(19) United States
(12) Patent Application Publication
(10) Pub. No.: US 2006/0219506 A1
(43) Pub. Date: Oct. 5, 2006

(54) Shock absorber including supplemental friction generating device

(76) Inventor: David Thomas Zdeb, Ypsilanti, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/094,889

(22) Filed: Mar. 31, 2005

(51) Int. Cl. F16F 9/50

(52) U.S. Cl. 188/322.16

(57) ABSTRACT

A shock absorber includes a hydraulic fluid-filled cylinder, a piston moveably disposed within the cylinder, a piston rod attached to the piston for movement therewith, a piston rod seal sealingly engaging the piston rod and adapted to inhibit leakage of hydraulic fluid from the cylinder, and a friction member engaging the piston rod to provide friction damping. In an embodiment, the friction member includes a flexible membrane that contacts the piston rod and a biasing member adapted to apply a radially inwardly directed biasing force against the flexible membrane such that a given level of friction is developed. A method for providing friction damping in a shock absorber is also disclosed.

### BACKGROUND OF THE INVENTION

1. Field of the Invention

The present invention relates to vehicle shock absorbers including a hydraulic shock absorber having a friction generating device to improve damping properties.

2. Description of the Related Art

Hydraulic shock absorbers for motor vehicles generally include a single piston and oil-filled cylinder arrangement used in combination with a coil spring. A piston rod is connected to the piston within the cylinder with its free end protruding from the cylinder for attachment to the body of a vehicle. The cylinder is attached to the vehicle wheel suspension. Extension or compression of the shock absorber, caused when the wheel suspension passes over a rough surface and elastically deforms the coil spring, is damped by resistance to movement of the piston within the oil-filled cylinder. The damping resistance to movement of the piston may be provided by a valve mechanism on the piston, which restricts the flow of oil from one side of the piston to the other inside within the cylinder. Shock absorbers also exhibit an inherent frictional damping component by virtue of the shock absorber component parts being in physical contact. For example, in a twin-tube style damper, the friction dampening is generated by the rod-to-seal interface, the seal-to-tube interface, and the rod guide-to-rod interface.

Recently, it has been determined that vehicle handling stability during transient maneuvers may be improved by increasing the friction damping component and spring rate of the shock absorber operation. In qualitative terms, the increased friction level in the shock absorber improves handling stability feel of the vehicle, while the spring rate reduces specific road vibration frequencies. These parameters are generally mutually exclusive and prior art shock absorbers have not yet presented a flexible, tunable solution that balances handling stability feel and ride vibration. In one prior art shock absorber, for example, a friction control device is located near the shock absorber seal and rod guide adjacent the top of the shock cylinder and includes an relatively inflexible elastomeric ring. Among other limitations, this configuration significantly increases the amount of friction damping and spring rate, which in some vehicle operating conditions may adversely affect road handling, stability feel, and the amount of ride vibration. Moreover, the elastomeric ring in the prior art friction control device cannot be readily tuned to provide a wide range spring rates. For at least these reasons, an improved shock absorber is desired that overcomes limitations of the prior art.

### SUMMARY OF THE INVENTION

A shock absorber is provided that includes a hydraulic fluid-filled cylinder and a piston moveably disposed within the cylinder. A piston rod is attached to the piston for movement therewith and a piston rod seal sealingly engaging the piston rod to inhibit leakage of hydraulic fluid from the cylinder. The shock absorber also includes a friction member that engages the piston rod to provide a select amount of friction damping. In an embodiment, the friction member includes a flexible membrane that contacts the piston rod and a biasing member adapted to apply a radially inwardly directed biasing force against the flexible membrane such that a given level of friction is developed by virtue of the flexible membrane forcibly contacting the piston rod. A method for providing friction damping in a shock absorber is also disclosed.

Other aspects of the invention will be apparent to those skilled in the art after review of the drawings and detailed description provided below.

### BRIEF DESCRIPTION OF THE DRAWINGS

Embodiments of the invention will now be described, by way of example, with reference to the accompanying drawings, wherein:

FIG. 1 is a cross-sectional view of a shock absorber according to an embodiment of the present invention;

FIG. 2 is a detailed view of the shock absorber shown in FIG. 1; and

FIG. 3 is a graphical illustration of an input force versus displacement curve for a shock absorber according to an embodiment of the present invention.

### DETAILED DESCRIPTION

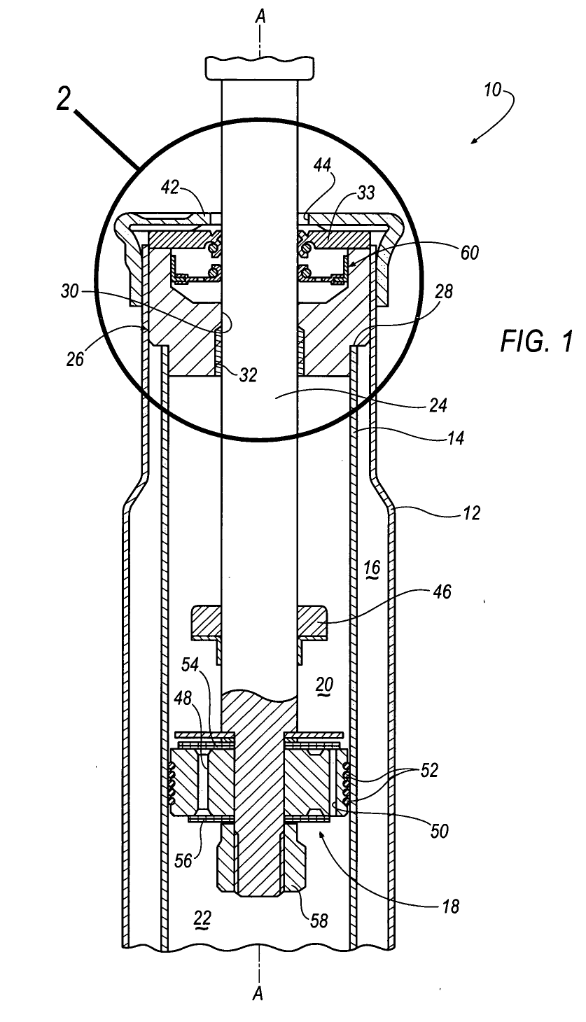

Referring to FIG. 1, a cross-sectional view of a telescopic fluid pressure shock absorber 10 is shown according to an embodiment of the present invention. Shock absorber 10 includes an outer casing 12 that extends along an axis A-A and a hydraulic fluid filled cylinder 14 that extends along the same axis and is contained within outer casing 12. Outer casing 12 and cylinder 14 define a reservoir 16 that may be filled with hydraulic fluid of specified quantity. When equipped as a gas-charged shock absorber, outer casing 12 and/or cylinder 14 may contain pressurized gas, such as nitrogen, to inhibit the formation of gas bubbles (e.g., cavitation) that may compromise the incompressibility of the hydraulic fluid.

A piston 18 is moveably disposed within cylinder 14 and separates the cylinder 14 into first and second chambers 20 and 22. Piston 18 is attached to a piston rod 24, which together are capable of moving in a closing direction (compression) and an opening direction (rebound). Although not shown in FIG. 1, piston rod 24 is adapted to be connected or attached to a vehicle suspension component and outer casing 12 is adapted to be connected or attached to the body of the vehicle.

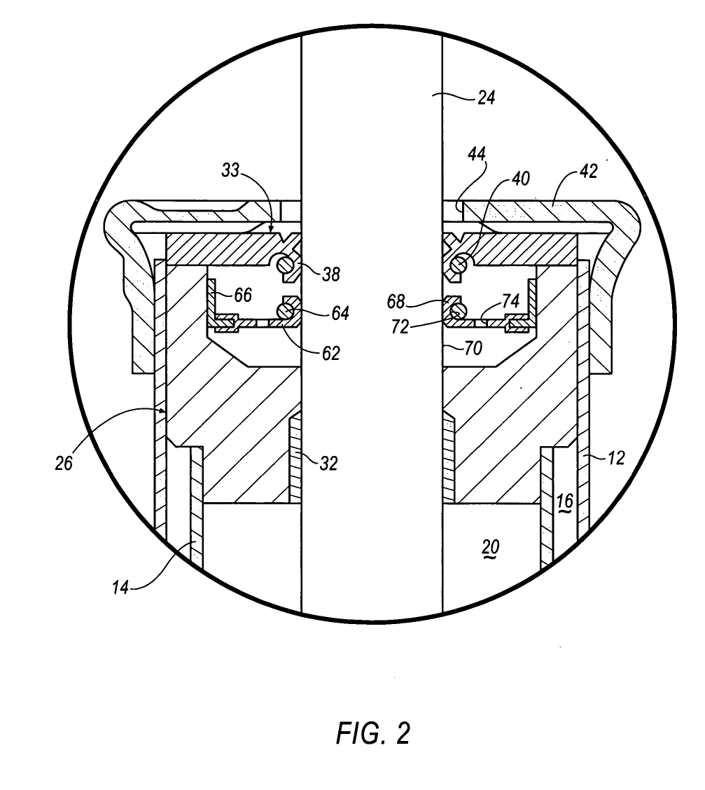

In the illustrated embodiment, a rod guide 26 is positioned at an end 28 of cylinder 14 and includes a bore 30 containing an optional annular bushing 32 that supports sliding movement of piston rod 24. A piston rod seal 33 is positioned between rod guide 26 and piston rod 24. In the illustrated configuration, piston rod seal 33 includes a lip-style sealing member 38 (see FIG. 2) made of a polymeric material, such as rubber. Sealing member 38 may be spring energized, as shown in FIG. 2, by a coil spring 40 or other resiliently expandable member. A contoured inner circumferential surface of piston rod seal 33 sealably engages a peripheral surface of piston rod 24 to inhibit leakage of hydraulic fluid from cylinder 14 and the ingression of contaminants, such as dirt and water, into cylinder 14.

A cap 42 covers outer casing 12 and includes an aperture 44 through which piston rod 24 extends. A piston rod stop 46, such as an elastomer-bound piston rod stop, may be secured to piston rod 24 for movement therewith. When so configured, piston rod stop 46 can be adapted to engage rod guide 26 to regulate the stroke of piston 18.

In an embodiment, piston 18 includes first and second ducts 48 and 50, which pass through piston 18 generally parallel to axis A-A, and provide first chamber 20 in communication with second chamber 22 so that hydraulic fluid is free to pass through piston 18 as the piston moves within cylinder 14. In the illustrated embodiment, piston 18 also includes at least one piston ring 52 and a pair of deflectable disc-shaped valve members 54 and 56 that cooperate with first and second ducts 48, 50 to regulate fluid flow between first and second chambers 20, 22 as piston 18 moves within cylinder 14. A nut 58 may be used to secure piston 18 and valve members 54, 56 to piston rod 24.

If a differential pressure arises between first and second chambers 20, 22 as the piston moves within cylinder 14, one of valve members 54 or 56 (depending on the direction of fluid flow) will bend and/or transform to form an orifice adjacent a corresponding duct 48 or 50. The level of hydraulic damping provided by shock absorber 10 varies in direct proportion to the velocity of piston 18 and, correspondingly, the velocity of fluid flow through duct 48 or 50 and the size of the resulting orifice created by valve member 54 or 56.

Referring to FIGS. 1 and 2, shock absorber 10 also includes a friction member 60 that engages the piston rod 24 to provide a select amount of friction damping. In an embodiment, friction member 60 includes a flexible membrane 62 that contacts piston rod 24 and a biasing member 64 adapted to apply a radially inwardly directed biasing force against membrane 62 such that a given level of friction is developed by virtue of the flexible membrane 62 forcibly contacting a portion of piston rod 24. Polymeric materials, such as elastomers, plastics and the like, are particularly suited for use in flexible membrane 62 given their relative flexibility and favorable coefficient of friction properties.

In the illustrated embodiment, flexible membrane 62 is connected or affixed to an annular retainer 66, which is press-fit or otherwise fixedly secured to rod guide 26. To facilitate retention of biasing member 64 against flexible member 62, the flexible membrane 62 may include a contoured inner circumferential portion 68 that contacts a peripheral surface 70 of piston rod 24. For example, without limitation, contoured inner circumferential portion 68 may be generally cup-shaped and the biasing member may be received in a generally cup-shaped opening 72 defined by the contoured inner circumferential portion 68. When so configured, biasing member 64 may include a garter spring or other resiliently expandable and contractible device that can be readily installed into or removed from opening 72. At least one hole or aperture 74 may be provided in flexible membrane 62 to equalize the fluid pressure on either side of the membrane.

Unlike prior art shock absorbers that typically include a relatively inflexible elastomer ring that, by virtue of its material properties and shape, develops the requisite biasing force against the piston rod, friction member 60 of the present invention includes a relatively flexible membrane 62 and a biasing member 64 adapted to apply a radially inwardly directed biasing force against the flexible membrane 62 such that a select or predetermined level of friction is developed between flexible membrane 62 and piston rod 24. Among other features, friction member 60 may be readily “tuned” by selecting a biasing member that produces a desired biasing force, without necessarily modifying the material properties or shape of flexible membrane 62. For example, the level of static friction damping in shock absorber 10 may be achieved by first determining the level of static friction damping desired in the shock absorber and then, through calculation or experimentation, selecting a biasing member 64 from a group of distinct biasing members, each biasing member adapted to apply a given or predetermined biasing force against flexible membrane 62 when installed in a given shock absorber 10.

Operation of shock absorber 10 will now be discussed with reference to FIGS. 1 and 2. During vehicle maneuvers, undesirable and excess motion in a vehicle body or suspension may be created, among other ways, by the irregularity and/or curvature of the road surface and vehicle braking. This motion forces piston 18 to be displaced relative to cylinder 14. By forcing piston 18 through hydraulic fluid, shock absorber 10 develops hydraulic friction to resist the undesirable and excess body or suspension motion. More particularly, the motion applied to piston 18 pressurizes the fluid and forces it to flow through the restricting orifices created by valve members 54, 56, causing the hydraulic fluid to rapidly heat. The thermal energy is transferred to cylinder 14 and outer casing 12, and then harmlessly dissipated to the atmosphere.

As noted above, the damping capacity of shock absorber 10 varies in direct proportion to the velocity of piston 18 and, correspondingly, the velocity of the fluid flow through the piston orifices. However, during transient vehicle maneuvers when the speed with which piston 18 moves in relation to cylinder 14 is relatively low, circulation of hydraulic fluid through the restricting orifices is generally not enough to attenuate undesirable and excess body or suspension motion. To overcome the lack of hydraulic damping during transient vehicle maneuvers, friction member 60 provides a friction force to impart drag on piston rod 24 as the piston rod moves relative thereto. The friction force generated by friction member 60 is independent of the piston speed or oscillating input frequency of piston rod 24 and, therefore, improves the vehicle stability and handling, and reduces the transmission of road induced suspension vibrations to the vehicle occupants when hydraulic damping is not possible.

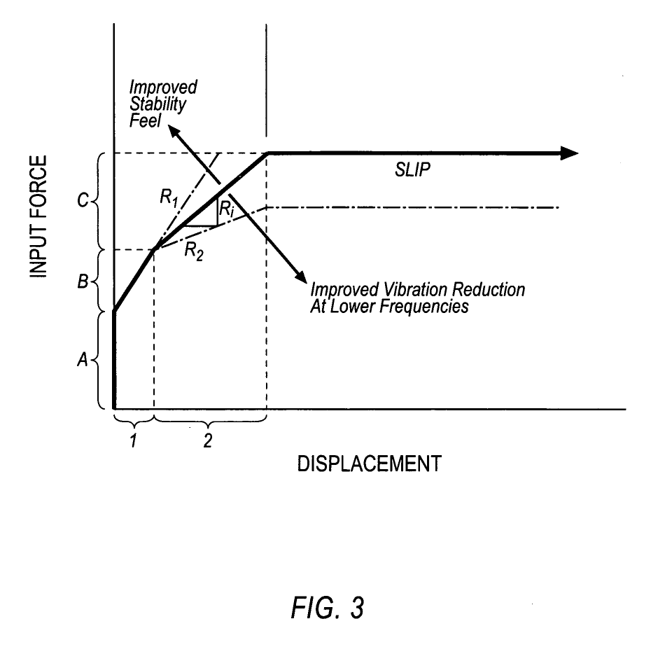

Referring to FIG. 3, a graphical illustration of an input force versus displacement curve for a shock absorber 10 according to an embodiment of the present invention is shown. An input force applied to shock absorber 10 causes piston 18 to be displaced relative to cylinder 14. As the input force is applied, piston rod 24 is initially stationary due to the static friction force applied against piston rod 24 by rod guide 26, piston rod seal 33 and friction member 60 (see, e.g., section A of the input force). As the input force increases, piston rod 24 is displaced relative to cylinder 14, while only piston rod seal 33 and friction member 60 apply a static friction force against piston rod 24 as they deflect relative to cylinder 14 and/or rod guide 26 (see, e.g., section B along the input force axis and section 1 along the displacement axis). As the input force further increases, piston rod 24 is further displaced relative to cylinder 14, while only friction member 60 applies a static friction force against piston rod 24 as it deflects relative to cylinder 14 and/or rod guide 26 (see, e.g., section C along the input force axis and section 2 along the displacement axis). When the displacement of piston rod 24 exceeds the ability of friction member 60 to further deflect, the rod guide 26, piston rod seal 33 and friction member 60 all apply a dynamic friction force against piston rod 24 as the piston rod 24 slips past each of the components.

As noted above, friction member 60 may be “tuned” to achieve the desired friction damping and spring rate. In a particular application, the displacement of piston rod 24 relative to cylinder 14 for a given increase in input force (R1 in FIG. 3) may be modified by substituting one biasing member 64 for another having a different radially inwardly directed biasing force. For example, vehicle stability feel may be improved by decreasing the displacement of piston rod 24 relative to cylinder 14 for a given increase in input force (e.g., R1 in FIG. 3). Alternatively, for example, low-frequency vehicle vibration reduction may be improved by increasing the displacement of piston rod 24 relative to cylinder 14 for a given increase in input force (e.g., R₂ in FIG. 3).

In another application, the displacement of piston rod 24 relative to cylinder 14 for a given increase in input force (R1 in FIG. 3) may be modified by adjusting one or more properties of flexible membrane 62. For example, the thickness of flexible membrane 62 or the coefficient of friction of the polymeric material used in flexible membrane 62 may be modified or adapted to control the amount of membrane deflection before slip.

It will be appreciated that the present invention is not limited to the shock absorber design illustrated in FIG. 1 and described above, and that friction member 60 of the present invention may be used in other telescopic fluid pressure shock absorber designs that employ a piston-separated hydraulic fluid chamber configuration. The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A shock absorber, comprising:
a hydraulic fluid-filled cylinder;
a piston moveably disposed within the cylinder;
a piston rod attached to the piston for movement therewith;
a piston rod seal sealingly engaging the piston rod and adapted to inhibit leakage of hydraulic fluid from the cylinder; and
a friction member engaging the piston rod to provide a select amount of friction damping, the friction member including a flexible membrane that contacts the piston rod and a biasing member adapted to apply a radially inwardly directed biasing force against the flexible membrane such that a given level of friction is developed by virtue of the flexible membrane forcibly contacting a portion of the piston rod.

2. The shock absorber of claim 1, wherein the flexible membrane is affixed to an annular retainer.

3. The shock absorber of claim 1, wherein the flexible membrane comprises a polymeric material.

4. The shock absorber of claim 1, wherein the flexible membrane includes a contoured inner circumferential portion that contacts a peripheral surface of the piston rod.

5. The shock absorber of claim 4, wherein the contoured inner circumferential portion is generally cup-shaped and the biasing member is received in a generally cup-shaped opening defined by the contoured inner circumferential portion.

6. The shock absorber of claim 1, wherein the biasing member includes a garter spring.

7. The shock absorber of claim 1 further including a piston rod guide positioned at an end of the cylinder through which the piston rod extends.

8. The shock absorber of claim 7, wherein the piston rod guide includes an aperture containing an annular bushing that supports sliding movement of the piston rod.

9. The shock absorber of claim 7 further including a piston rod seal positioned between the piston rod guide and the piston rod.

10. The shock absorber of claim 9 further including an outer casing, wherein the piston rod seal is positioned between the piston rod and the outer casing.

11. The shock absorber of claim 10 further including a cap covering an end of the outer casing and including an aperture through which the piston rod extends.

12. The shock absorber of claim 9, wherein the piston rod seal includes an annular retainer and a lip-style sealing member affixed to the retainer.

13. The shock absorber of claim 12, wherein the lip-style sealing member is spring energized.

14. The shock absorber of claim 9, wherein a contoured inner circumferential surface of the piston rod seal sealably engages a peripheral surface of the piston rod and is adapted to inhibit leakage of hydraulic fluid from the cylinder and the ingression of contaminants into the cylinder.

15. The shock absorber of claim 1 further including an elastomer bound piston rod stop secured to the piston rod for movement therewith, the piston rod stop adapted to regulate the stroke of the piston.

16. The shock absorber of claim 1, wherein the piston includes at least one duct that passes through the piston such that hydraulic fluid is free to pass through the piston as the piston moves within the cylinder.

17. The shock absorber of claim 16, wherein the piston includes a deflectable valve member that cooperates with the duct to regulate fluid flow through the piston as the piston moves within the cylinder.

18. A shock absorber, comprising:
a hydraulic fluid-filled cylinder;
a piston moveably disposed within the cylinder;
a piston rod attached to the piston;
a rod guide positioned at an end of the cylinder that slidingly supports the piston rod;
a piston rod seal including an inner circumferential surface sealably engaged with a peripheral surface of the piston rod to inhibit leakage of hydraulic fluid from the cylinder; and
a friction member engaging the piston rod to provide a select amount of friction damping, the friction member including a flexible membrane that contacts the piston rod and a biasing member adapted to force the flexible membrane against the piston rod such that a given level of friction is developed therebetween, wherein the membrane includes a generally cup-shaped inner circumferential portion and the biasing member comprises a garter spring received in an opening defined by the inner circumferential portion.

19. A method for providing friction damping in a shock absorber, the method comprising the steps of:
providing a hydraulic fluid-filled cylinder, a piston moveably disposed within the cylinder, a piston rod attached to the piston for movement therewith, a piston rod seal sealingly engaging the piston rod and adapted to inhibit leakage of hydraulic fluid from the cylinder, and a friction member engaging the piston rod, the friction member including a flexible membrane that contacts the piston rod and a biasing member adapted to apply a radially inwardly directed biasing force against the flexible membrane such that a given level of friction is developed by virtue of the flexible membrane forcibly contacting the piston rod;
determining the level of friction damping desired in the shock absorber; and
selecting a biasing member from a group of distinct biasing members, each biasing member adapted to apply a given biasing force against the flexible membrane when installed in the shock absorber.
